(19) United States
(12) Patent Application Publication
(10) Pub. No.: US 2016/0243815 A1
(43) Pub. Date: Aug. 25, 2016

(54) EMBOSSING APPARATUS

(71) Applicant: Graphtec Corporation, Kanagawa (JP)

(72) Inventors: Ryoichi Oka, Kanagawa (JP); Kazuhiro Watanabe, Kanagawa (JP); Tsutomu Ohira, Kanagawa (JP)

(21) Appl. No.: 15/048,253

(22) Filed: Feb. 19, 2016

(30) Foreign Application Priority Data
Feb. 23, 2015 (JP) 2015-032569

(51) Int. Cl. B41F 19/02

(52) U.S. Cl. CPC B41F 19/02

(57) ABSTRACT

An embossing apparatus includes a base, a work table, a mat, a pen carriage and a first tool. The base includes a conveyance path extending in a first direction. The work table is attached to the conveyance path and moves in the first direction. The mat is arranged on the work table. The pen carriage is spaced apart from the base and moves in the second direction parallel to the major surface of the work table and different from the first direction. The first tool is arranged on the pen carriage and moves in the third direction perpendicular to the major surface of the work table. The first tool moves in the third direction and is pressed against a medium adhered on the mat, thereby forms a recess in the medium.

### BACKGROUND OF THE INVENTION

The present invention relates to an embossing apparatus for performing embossing by pressing a processing tool against a sheet-like medium to be processed.

A process of forming a relief-like uneven pattern on a sheet-like medium to be processed is called embossing. An embossing apparatus for performing this embossing on a medium to be processed is disclosed in, e.g., Japanese Utility Model Registration No. 3125849 (literature 1). This embossing apparatus disclosed in literature 1 adopts an arrangement using a die and press. The die includes a convex die having a projection for forming a convex portion on a medium to be processed, and a concave die having a concave portion in which the projection of the convex is fitted.

To perform embossing by using the convex and concave dies, a medium to be processed is first sandwiched between the convex and concave dies. Then, these convex and concave dies are loaded into a press, and the press presses the convex and concave dies against the medium to be processed. After this pressing, the convex and concave dies are opened, and the medium to be processed is taken out. Consequently, an embossed medium to be processed is obtained.

To emboss a sheet-like medium to be processed, it is also possible to use an embossing apparatus disclosed in Japanese Patent Laid-Open No. 2001-277353 (literature 2). This embossing apparatus disclosed in literature 2 includes a platen roller having a function of feeding a belt-like medium to be processed, and an embossing tool to be pressed against the medium to be processed on this platen roller. The belt-like medium to be processed is used as it is pulled out from a supply reel arranged adjacent to the platen roller.

The platen roller is formed into a cylindrical shape having a size by which the medium to be processed can be wound, and rotates when driven by a driving device. The outer circumferential surface of this platen roller is elastic. Also, sprockets are formed in the two end portions of the platen roller in the axial direction. These sprockets engage with large numbers of feed holes formed on the two side portions of the medium to be processed, and feed the medium to be processed in the longitudinal direction as the platen roller rotates.

The embossing tool has a rotatable ball to be pressed against the medium to be processed. This embossing tool is supported by a tool head, and arranged in a position above the platen roller and opposite to the platen roller with the medium to be processed being sandwiched between them. The tool head has a function of selectively pressing the embossing tool against the medium to be processed, and a function of moving the platen roller together with the embossing tool in the axial direction.

In this embossing apparatus, an embossed portion having a recess is formed on the medium to be processed by pressing the ball of the embossing tool is pressed against the medium to be processed. Embossing is performed by operating the platen roller and tool in a state in which the embossed portion is thus formed. The embossed portion extends in the longitudinal direction of the medium to be processed when the platen roller rotates. The embossed portion also extends in the widthwise direction of the medium to be processed when the tool head moves in the axial direction of the platen roller. That is, the embossing apparatus disclosed in literature 2 can perform embossing on an arbitrary shape because the platen roller and tool head cooperate with each other.

In the embossing apparatus disclosed in literature 1, processable uneven patterns are limited. This is so because an uneven pattern is determined by the die. To emboss an arbitrary uneven pattern, therefore, it is necessary to newly manufacture convex and concave dies. Also, when using dies, an uneven pattern is formed in a predetermined position for each die. This poses the problem that the degree of freedom of embossing is low.

By contrast, the embossing apparatus disclosed in literature 2 has the function of feeding a medium to be processed, and the function of moving the embossing tool in the widthwise direction of the medium to be processed. This obviates the need for the die, and makes it possible to perform embossing in a desired position of the medium to be processed.

Unfortunately, the embossing apparatus disclosed in literature 2 has a large size for the following two reasons. The first reason is that embossing is performed by pressing, from above, the embossing tool against the medium to be processed wound on the platen roller. That is, since embossing is performed in a position higher than the lower end portion of the embossing apparatus by the outer diameter of the platen roller, the embossing apparatus increases in size in the vertical direction. The second reason is that the medium to be processed is a belt-like medium, and is used as it is pulled out from the supply reel. That is, an installation space for the supply reel is necessary in a position adjacent to the platen roller, so the embossing apparatus including the supply reel increases in size in the feeding direction of the medium to be processed.

### SUMMARY OF THE INVENTION

The present invention has been made to eliminate the problems as described above, and has as its object to provide an embossing apparatus which is downsized although it can perform embossing in an arbitrary position without using any die.

To achieve this object, the embossing apparatus of the present invention includes a base including a conveyance path extending in a first direction, a work table formed into a plate shape, and detachably attached to the conveyance path such that the work table is movable in the first direction with a major surface of the work table being parallel to the conveyance path, a mat which is arranged on the work table, and formed into a plate shape by a material having flexibility and elasticity, and on which a medium to be processed is adhered, a first driving device configured to move the work table in the first direction, a pen carriage spaced apart from the base, and supported to be movable in a second direction parallel to the major surface of the work table attached to the conveyance path and different from the first direction, a second driving device configured to move the pen carriage in the second direction, a first tool arranged on the pen carriage such that the first tool is movable in a third direction perpendicular to the major surface of the work table, and configured to form a recess in the medium to be processed when pressed against the medium to be processed adhered on the mat, a third driving device arranged on the pen carriage, and configured to move the first tool in the third direction, and selectively press the first tool against the medium to be processed adhered on the mat, and a control device configured to control operations of the first driving device, the second driving device, and the third driving device, and perform embossing on the medium to be processed by the first tool.

### BRIEF DESCRIPTION OF THE DRAWINGS

FIG. 1 is a perspective view of an embossing apparatus of an embodiment of the present invention;

FIG. 2 is an exploded perspective view of a movable stage;

FIG. 3 is a perspective view showing he lower surface of a work table;

FIG. 4 is a perspective view showing a part of an embossing apparatus main body in an enlarged scale;

FIG. 5 is a perspective view showing a part of a conveyor device in an enlarged scale;

FIG. 6 is a perspective view showing a part of the lower surface of the work table in an enlarged scale;

FIG. 7 is a sectional view showing a part of the embossing apparatus main body in an enlarged scale;

FIG. 8 is a perspective view showing a part of the embossing apparatus main body in an enlarged scale;

FIG. 9A is a side view of a first pen tool, and FIG. 9B is a longitudinal sectional view of the first pen tool;

FIG. 10 is a block diagram of a control system;

FIG. 11 is a flowchart showing a procedure of forming control data for embossing;

FIG. 12A is a plan view of a figure as a target of embossing, and FIGS. 12B to 12J are schematic views showing fill patterns;

FIG. 13 is a sectional view showing a part of an embossed medium to be processed in an enlarged scale;

FIG. 14 is a plan view showing the embossing apparatus in a storage state;

FIG. 15 is a front view of the embossing apparatus in the storage state; and

FIG. 16 is a plan view showing another embodiment of the movable stage.

### DESCRIPTION OF THE PREFERRED EMBODIMENT

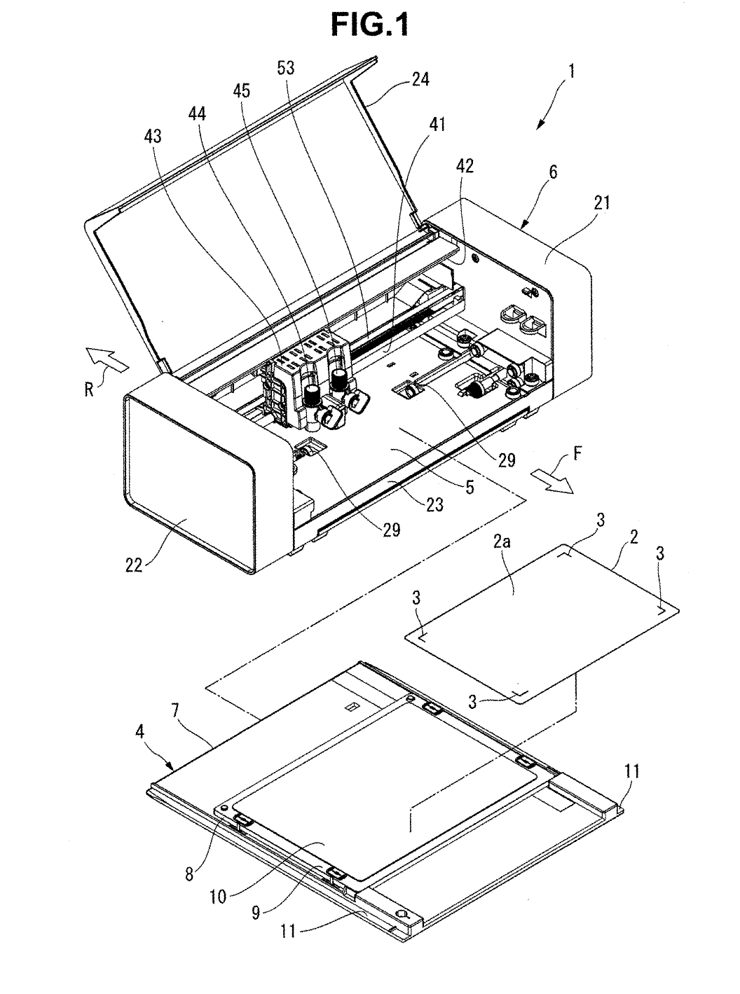

An embossing apparatus as an embodiment of the present invention will be explained in detail below with reference to FIGS. 1 to 15.

An embossing apparatus 1 shown in FIG. 1 is used to perform embossing on a sheet-like medium 2 to be processed. The sheet-like medium 2 to be processed is a sheet such as paper and, more specifically, a greeting card, message card, or postcard formed by paper. The medium 2 to be processed according to this embodiment has reference marks 3 indicating reference positions in order to specify processing positions when performing embossing. The reference marks 3 are preprinted in the reference positions of the medium 2 to be processed.

The embossing apparatus 1 includes a movable stage 4 for holding the media 2 to be processed as they are stacked, and an embossing apparatus main body 6 having a flat conveyance path 5 in which the movable stage 4 passes. The conveyance path 5 is formed in the bottom portion of the embossing apparatus main body 6 so as to extend in the back-and-forth direction. The back-and-forth direction herein mentioned is a direction parallel to a major surface 2a of the medium 2 to be processed, and pointing to a lower right position and an upper left position from the embossing apparatus main body 6 in FIG. 1. That is, the conveyance path 5 extends in the back-and-forth direction parallel to the major surface 2a of the medium 2 to be processed. In this embodiment, this back-and-forth direction is equivalent to “a first direction” of the present invention.

As will be described in detail later, the movable stage 4 moves in the back-and-forth direction as a direction in which the conveyance path 5 extends. In this embodiment, a direction pointing a lower right position from the embossing apparatus 1 in FIG. 1 (a direction which points the front of the embossing apparatus main body 6) is called “forward” and indicated by an arrow F in FIG. 1, for the sake of convenience. “Backward” is indicated by an arrow R in FIG. 1. Also, in the following description, a direction parallel to the major surface 2a of the medium 2 to be processed and perpendicular to the direction (back-and-forth direction) in which the conveyance path 5 extends will simply be called “a widthwise direction”. In this embodiment, this widthwise direction is equivalent to “a second direction” of the present invention.

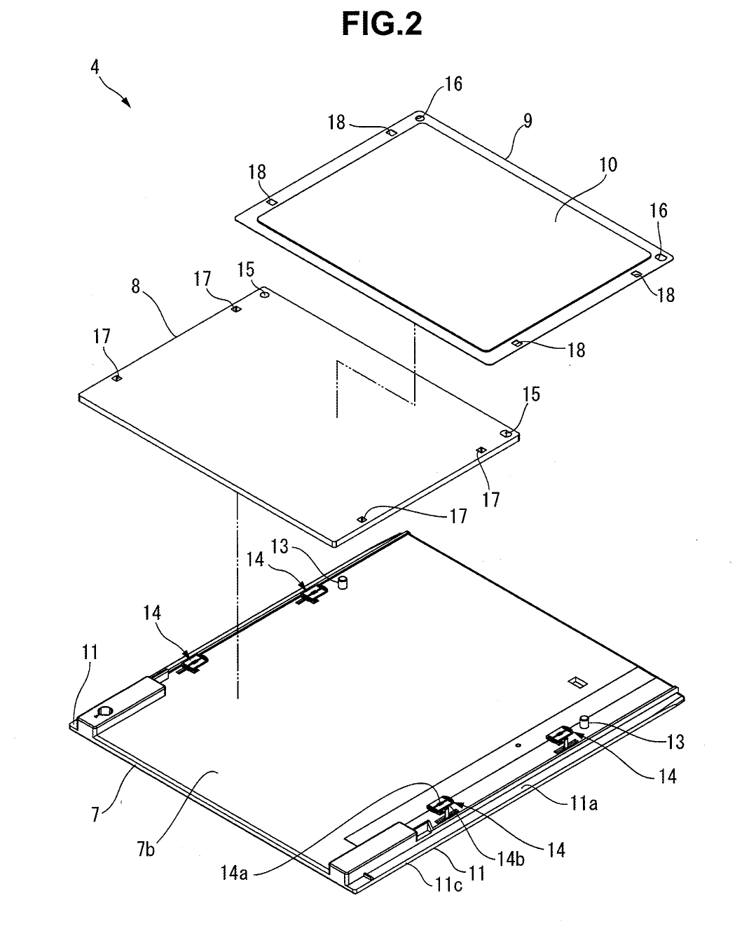

As shown in FIG. 2, the movable stage 4 is assembled by stacking a plurality of members in the vertical direction. The plurality of members are a work table 7 in the lowermost position in FIG. 2, and a plate-like spacer 8, base plate 9, and mat 10 arranged above the work table 7. The plate-like spacer 8, base plate 9, and mat 10 are stacked in this order. The work table 7 is formed into a plate shape by using a rigid material.

The plate-like spacer 8 is used to adjust the height of the mat 10. A plurality of different types of spacers different in thickness are prepared as the plate-like spacer 8, and a spacer having a thickness corresponding to the thickness of the medium 2 to be processed is used. In this embodiment, 3-mm, 2-mm, and 1-mm thick plate-like spacers 8 are prepared. As the material for forming the plate-like spacer 8, it is possible to use a rigid plastic material or a light-weight material such as so-called sponge. The base plate 9 is formed into a thin plate shape by using PET (polyethylene terephthalate).

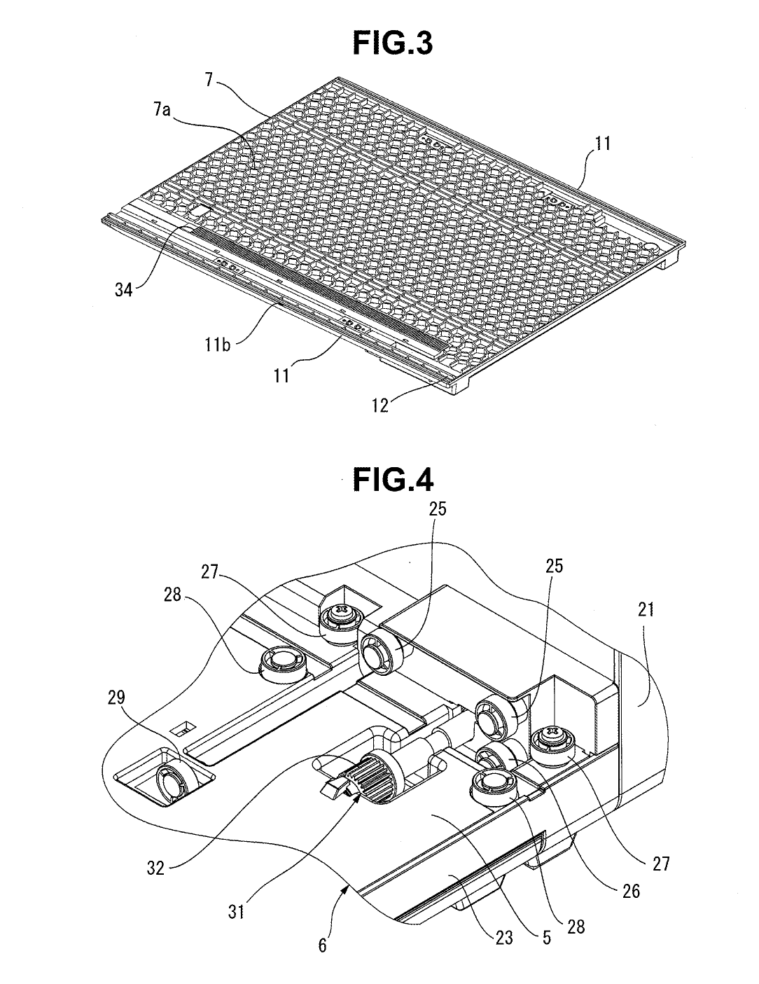

The work table 7 is formed by a rigid plastic material which hardly bends. A honeycomb reinforcing rib 7a (see FIG. 3) is formed on the lower surface of the work table 7 in order to minimize deformation. As shown in FIG. 2, a flat placement surface 7b overlapping the entire region of the lower surface of the plate-like spacer 8 is formed on the upper surface of the work table 7. The placement surface 7b is equivalent to “a major surface” of the work table 7 of the present invention. First guide rails 11 functioning as guides when the work table 7 moves along the conveyance path 5 (to be described later) are formed in the two ends of the work table 7 in the widthwise direction. As shown in FIG. 3, a second guide rail 12 is formed in one end portion of the lower surface of the work table 7 in the widthwise direction. The first and second guide rails 11 and 12 are formed into thin plate shapes extending in the back-and-forth direction from one end to the other of the work table 7.

The first guide rail 11 is formed into a plate shape which extends in the back-and-forth direction and projects outside the work table 7 in the widthwise direction. Of the first guide rail 11, an upper surface 11a and lower surface 11b (see FIG. 3) and an outer end face 11c in the widthwise direction are used as guide surfaces. The second guide rail 12 is formed in an end portion positioned on the right side when viewed from above with respect to the moving direction when the work table 7 moves backward. The second guide rail 12 is formed into a plate shape which extends in the back-and-forth direction and projects downward from the work table 7. Of the two side surfaces of the second guide rail 12 in the widthwise direction, one end face pointing the center of the work table 7 in the widthwise direction is used as a guide surface.

In the two end portions of the work table 7 in the widthwise direction, as shown in FIG. 2, two pins 13 for positioning the plate-like spacer 8 and base plate 9 and four clamping mechanisms 14 for fixing other members of the movable stage 4 on the work table 7 are formed.

The two pins 13 are formed on the upper surface of the work table 7 by monolithic molding, so as to have a shape which projects upward. The pins 13 fit in through holes 15 and 16 respectively formed in the plate-like spacer 8 and base plate 9.

The clamping mechanism 14 has a structure which holds another member by vertically clamping the member in cooperation with the work table 7. The clamping mechanism 14 includes an axial member 14a extending through other members of the movable stage 4, and a stopper plate 14b detachably locked by the axial member 14a. The axial member 14a is inserted into a through hole 17 of the plate-like spacer 8 and a through hole 18 of the base plate 9. The stopper plate 14b is locked from above by the axial member 14a projecting upward from the base plate 9 in the uppermost position. Although not shown, a large number of blades are vertically arranged on the axial member 14a. When pressed downward by a worker (not shown), the stopper plate 14b moves down over the tip of the blade, and is locked by the next blade. When this locked state is canceled and the stopper plate 14b is unlocked from the blade, the stopper plate 14b can be removed upward from the axial member 14a.

The mat 10 is formed into a plate shape having a predetermined thickness by using a flexible elastic material, and adhered on the base plate 9 by using, e.g., an acrylic adhesive. The material forming the mat 10 according to this embodiment is a soft foam. The medium 2 to be processed can easily be adhered on and separated from the surface of the mat 10. A surface like this can be implemented by using a soft foam having self-adsorption as the material of the mat 10, or coating the surface of foam having no self-adsorption with an adhesive material. The self-adsorption herein mentioned is a property which allows easy adhesion and separation without using any adhesive. The self-adsorption is implemented by micro suckers (not shown) obtained by a large number of fine recesses formed in the surface of the soft foam.

The mat 10 is adhered on the base plate 9 and fixed together with the plate-like spacer 8 on the work table 7 by the above-described clamping mechanisms 14. The medium 2 to be processed is adhered on the mat 10 from above. Note that when the adhesion of the surface of the mat 10 weakens, the mat 10 can be replaced with a new one together with the base plate 9, or can be separated from the base plate 9 and replaced with a new one.

As shown in FIG. 1, the embossing apparatus main body 6 includes a pair of sidewalls 21 and 22 positioned on the two sides of the conveyance path 5 in the widthwise direction, a bottom wall 23 connecting the sidewalls 21 and 22 below the conveyance path 5, and an opening/closing cover 24 for covering the conveyance path 5 from above. In this embodiment, the pair of sidewalls 21 and 22 and bottom wall 23 form “a base” of the present invention.

In the boundary portions between the sidewalls 21 and 22 and bottom wall 23, which are also the two end portions of the conveyance path 5 in the widthwise direction, a plurality of rollers 25 to 28 (see FIG. 4) for regulating the movement of the work table 7 in the vertical direction and widthwise direction are formed.

Of these rollers, rollers for regulating the vertical movement of the work table 7 are upper rollers 25 and lower rollers 26 which rotate along the widthwise direction of the conveyance path 5 as an axial direction. The upper rollers 25 rotate in contact with the upper surface 11a (see FIG. 2) of the first guide rail 11 of the work table 7. The lower rollers 26 rotate in contact with the lower surface 11b (see FIG. 3) of the first guide rail 11. The upper rollers 25 are arranged in three portions of the conveyance path 5 in the back-and-forth direction. The lower rollers 26 are arranged below two upper rollers 25, of the upper rollers 25 in the three portions, which are positioned in the two end portions of the conveyance path 5 in the back-and-forth direction. The lower rollers 26 are arranged in positions where they clamp the first guide rail 11 in the vertical direction in cooperation with the upper rollers 25. Therefore, the work table 7 is held to be movable in the back-and-forth direction in the conveyance path 5 such that the vertical movement is regulated by the upper rollers 25 and lower rollers 26 in the two end portions in the back-and-forth direction and the two end portions in the widthwise direction.

Rollers for regulating the movement of the work table 7 in the widthwise direction are outer rollers 27 and inner rollers 28 which rotate in the vertical direction as an axial direction. The outer rollers 27 and inner rollers 28 are formed in only one end portion in the widthwise direction. This one end portion in the widthwise direction is an end portion positioned on the right side when the conveyance path 5 is viewed frontways. The outer rollers 27 rotate in contact with the end face 11c (see FIG. 2) of one first guide rail 11 of the work table 7. The one first guide rail 11 is the first guide rail 11 positioned on the right side when the work table 7 inserted into the conveyance path 5 is viewed frontways. The inner rollers 28 rotate in contact with the right-side end face of the second guide rail 12. This right-side end face is an end face positioned on the right side when the second guide rail 12 is viewed frontways. The outer rollers 27 and inner rollers 28 are formed in two portions of the conveyance path 5 in the back-and-forth direction.

The work table 7 is held by the rollers 25 to 28 when inserted frontways into the conveyance path 5. That is, the work table 7 is detachably attached to the conveyance path 5 so as to be movable in the back-and-forth direction (first direction) with the placement surface 7b (the major surface) being parallel to the conveyance path 5.

As shown in FIGS. 1 and 4, two center rollers 29 for supporting the central portion of the work table 7 are arranged on the bottom wall 23 of the embossing apparatus main body 6. The center rollers 29 are rotatably supported by the bottom wall 23 in the widthwise direction as an axial direction, and arranged at a predetermined interval in the widthwise direction.

As shown in FIG. 4, a pinion 32 as a part of a conveyor device 31 (to be described later) is also arranged on the bottom wall 23. The conveyor device 31 moves the work table 7 in the direction (back-and-forth direction) in which the conveyance path 5 extends. In this embodiment, the conveyor device 31 forms “a first driving device” of the present invention.

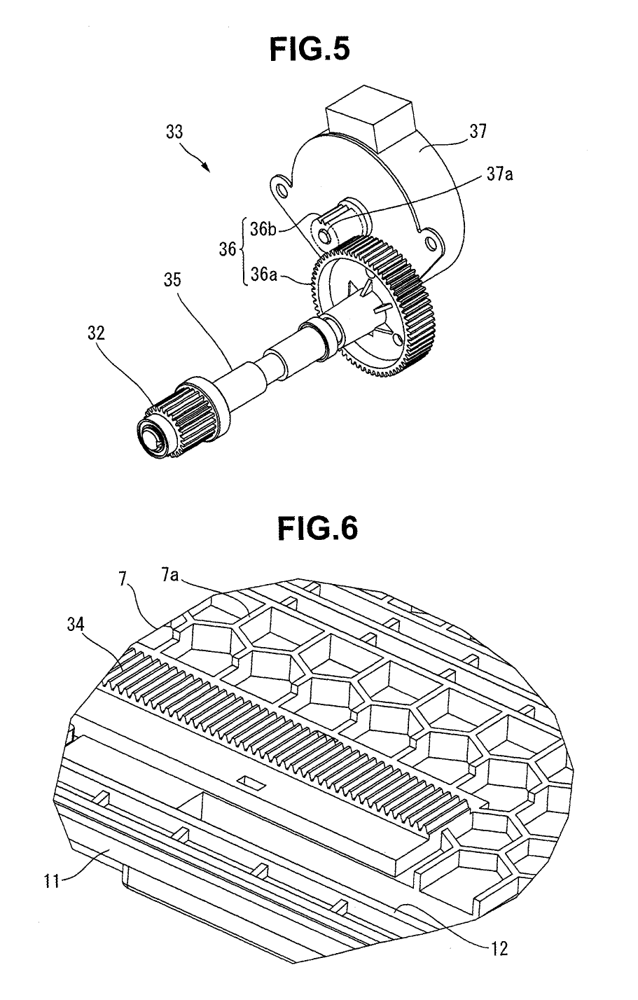

The conveyor device 31 includes a driving unit 33 (see FIG. 5) having the pinion 32, and a rack 34 (see FIG. 3) formed on the lower surface opposite to the placement surface 7b of the work table 7. The driving unit 33 is installed in the embossing apparatus main body 6. As shown in FIG. 5, the driving unit 33 includes the pinion 32 which meshes with the rack 34 described above, a rotating shaft 35 having one end portion on which the pinion 32 is formed, and a first motor 37 connected to the other end portion of the rotating shaft 35 via a speed reducing mechanism 36.

The speed reducing mechanism 36 includes a large-diameter gear 36a attached to the other end portion of the rotating shaft 35, and a small-diameter gear 36b attached to a rotating shaft 37a of the first motor 37. The driving unit 33 is arranged on one side of the conveyance path 5 in the widthwise direction. This one side is the right side when the conveyance path 5 is viewed frontways. The rotating shaft 35 is rotatably supported by the bottom wall 23 in the widthwise direction of the conveyance path 5 as an axial direction. A control device 39 (see FIG. 10) (to be described later) controls the operation of the first motor 37. When the rotating shaft 37a of the first motor 37 rotates, this rotation is transmitted to the pinion 32 via the speed reducing mechanism 36 and rotating shaft 35, and the pinion 32 rotates.

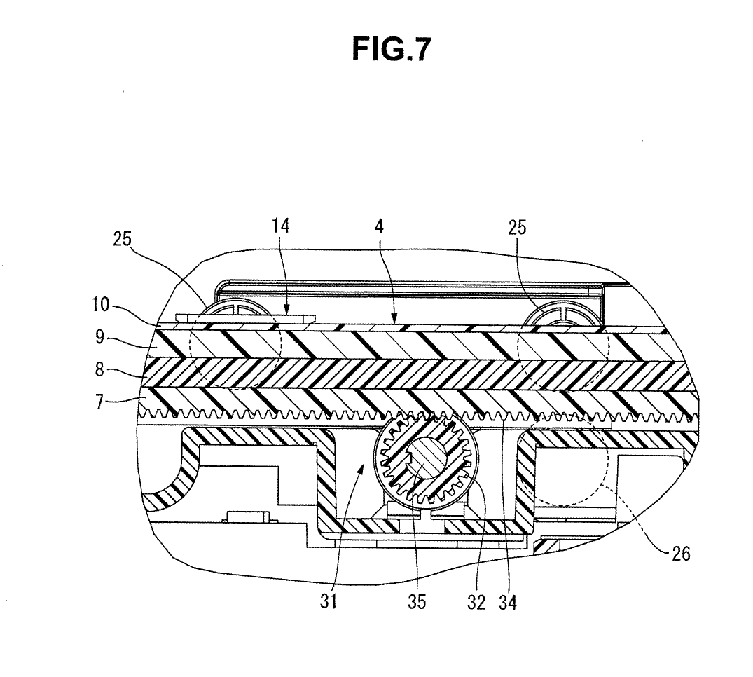

As shown in FIGS. 3 and 6, the rack 34 is formed parallel to the back-and-forth direction (the direction in which the conveyance path 5 extends) on that portion of the lower surface of the work table 7, which is close to the second guide rail 12. As shown in FIG. 7, the rack 34 meshes with the pinion 32 when the work table 7 is held by the plurality of rollers 25 to 28 described above. When the pinion 32 rotates forward or backward by being driven by the first motor 37, the movable stage 4 having the work table 7 moves forward or backward with respect to the embossing apparatus main body 6.

As shown in FIG. 1, the pair of sidewalls 21 and 22 of the embossing apparatus main body 6 support a lower guide rod 41 and upper guide rod 42 extending in the widthwise direction above the conveyance path 5. The lower and upper guide rods 41 and 42 are each formed by a pipe having a circular section, and are supported by the sidewalls 21 and 22 so as to be spaced apart from each other in the vertical direction. A pen carriage 43 (to be described later) is supported by the lower and upper guide rods 41 and 42 so as to be movable in the longitudinal direction of the rods 41 and 42. In other words, the pen carriage 43 is spaced apart from the bottom wall 23 (the base), and supported to be movable in the widthwise direction (a second direction) parallel to the placement surface 7b (the major surface) of the work table 7 attached to the conveyance path 5 and different from the back-and-forth direction (the first direction).

The pen carriage 43 movably supports a first pen tool 44 and second pen tool 45 in a third direction perpendicular to the placement surface 7b of the work table 7. In this embodiment, the third direction is the vertical direction.

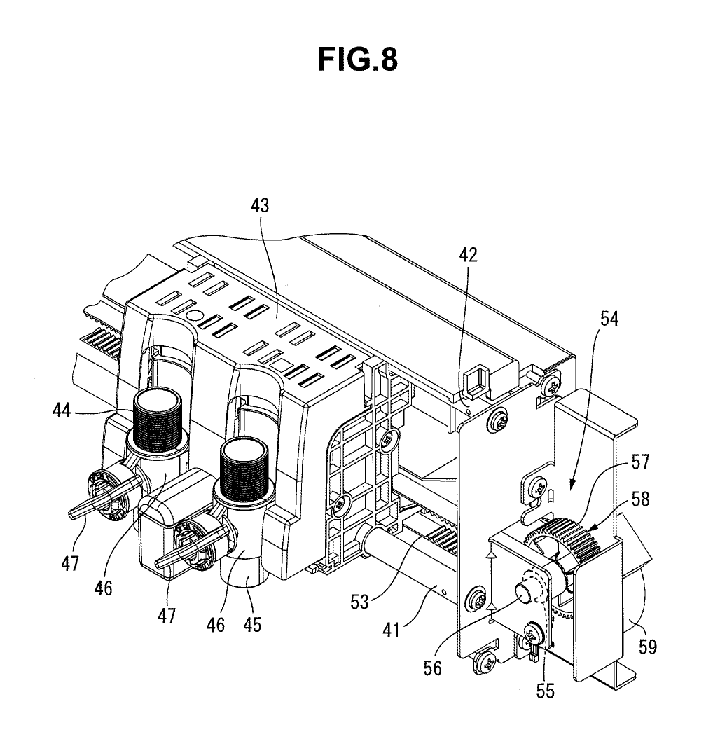

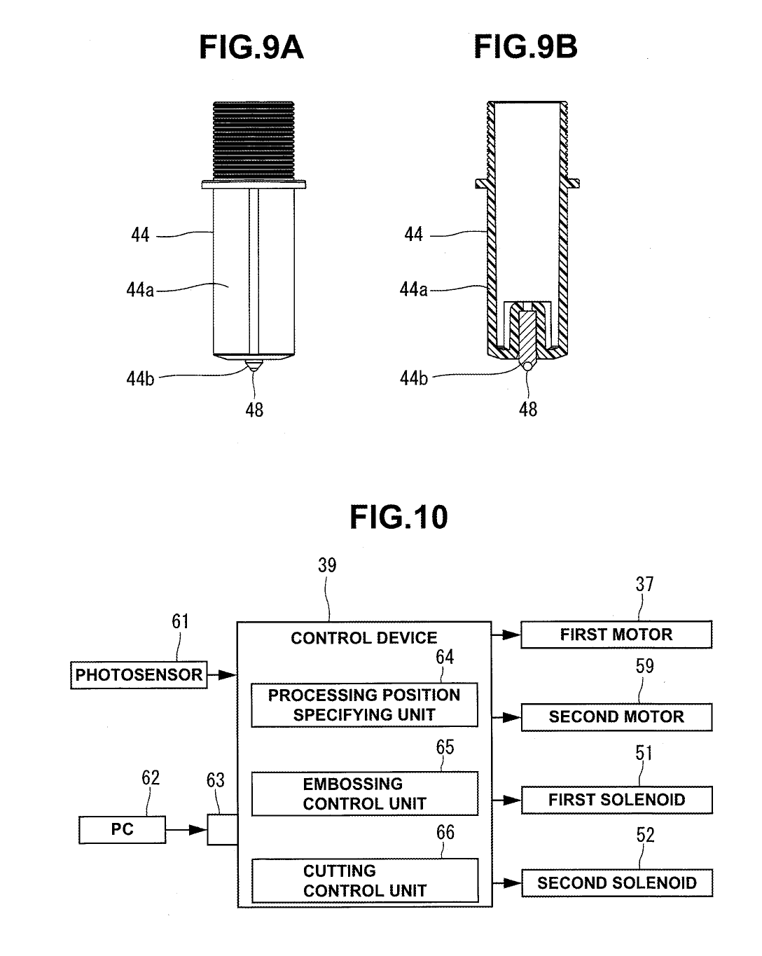

The first pen tool 44 is used to perform embossing. The first pen tool 44 is equivalent to “a first tool” of the present invention. As shown in FIGS. 9A and 9B, the first pen tool 44 includes a shaft 44a, and a tool main body 44b formed in the lower end portion of the shaft 44a. The shaft 44a is detachably attached to a pen holder 46 (see FIG. 8) of the pen carriage 43. The pen holder 46 has a lever 47 for switching a state in which the shaft 44a is fixed, and a state in which the shaft 44a is unfixed. As shown in FIGS. 9A and 9B, a ball 48 is rotatably attached to the distal end portion (lower end portion) of the tool main body 44b.

The second pen tool 45 is a so-called cutting pen. In this embodiment, the second pen tool 45 is equivalent to “a second tool” of the present invention. The second pen tool 45 has the same structure as that of the first pen tool 44 except for a tool main body (not shown). The tool main body of the second pen tool 45 has a blade capable of cutting the medium 2 to be processed. This blade projects downward from the lower end of the tool main body by a predetermined projection length. A worker can change the projection length of the blade projecting from the tool main body. When the projection length of the blade is larger than the thickness of the medium 2 to be processed, the medium 2 to be processed can be cut by the second pen tool 45. When the projection length of the blade is smaller than the thickness of the medium 2 to be processed, so-called half-cut can be performed on the medium 2 to be processed. Note that the second pen tool 45 can be an ink pen (not shown) capable of coloring the medium 2 to be processed, and can also be an embossing pen tool different from the first pen tool 44 in outer diameter of the ball 48.

The pen carriage 43 includes a first solenoid 51 (see FIG. 10) for vertically moving the first pen tool 44 (i.e., moving the first pen tool 44 in the third direction perpendicular to the placement surface 7b of the work table 7), and a second solenoid 52 for vertically moving the second pen tool 45 (i.e., moving the second pen tool 45 in the third direction). In this embodiment, the first solenoid 51 is equivalent to “a third driving device” of the present invention, and the second solenoid 52 is equivalent to “a fourth driving device” of the present invention. The control device 39 (to be described later) controls the operations of the first and second solenoids 51 and 52.

When driven by the first solenoid 51, the first pen tool 44 is pressed against the medium 2 to be processed. That is, the first solenoid 51 selectively presses the first pen tool 44 against the medium 2 to be processed. The second solenoid 52 selectively presses the second pen tool 45 against the medium 2 to be processed. When the second pen tool 45 is pressed against the medium 2 to be processed, the blade sticks into the medium 2 to be processed. When the second pen tool 45 is an ink pen, the pen point comes in contact with the medium 2 to be processed. That is, the second solenoid 52 selectively presses the second pen tool 45 against the medium 2 to be processed.

As shown in FIG. 8, a timing belt 53 extending in the horizontal direction is attached to the rear end portion of the pen carriage 43. The timing belt 53 forms a part of a widthwise-direction driving device 54 for moving the pen carriage 43 in the widthwise direction (second direction). The timing belt 53 is formed into an endless belt shape, wound around a driving pulley 55 (see FIG. 8) in the sidewall 21, and wound around a driven pulley (not shown) in the sidewall 22.

The widthwise-direction driving device 54 includes the timing belt 53, a rotating shaft 56 having the driving pulley 55 in one end portion, and a second motor 59 connected to the other end portion of the rotating shaft 56 via a speed reducing mechanism 58 including a large-diameter gear 57 and a small-diameter gear (not shown). The control device 39 (to be described later) controls the operation of the second motor 59. The pen carriage 43 moves in the widthwise direction when the driving pulley 55 rotates by being driven by the second motor 59, and this rotation is transmitted to the timing belt 53. In this embodiment, the widthwise-direction driving device 54 forms “a second driving device” of the present invention.

A photosensor 61 (see FIG. 10) is installed in the front end portion of the pen carriage 43. The photosensor 61 senses the reference mark 3 formed on the medium to be processed, and sends the sensed data as a signal to the control device 39. In this embodiment, the reference mark 3 is equivalent to “a mark” of the present invention.

The control device 39 is formed by using, e.g., a microprocessor, and implements a plurality of functional units (to be described later). As shown in FIG. 10, the first and second motors 37 and 59, first and second solenoids 51 and 52, photosensor 61, and the like are connected to the control device 39. The control device 39 also includes an interface 63 to which a personal computer (PC) 62 is connected, in order to receive data necessary for processing.

The plurality of functional units implemented by the control device 39 are a processing position specifying unit 64, embossing control unit 65, and cutting control unit 66. The processing position specifying unit 64 has a function of specifying the position of the medium 2 to be processed with respect to the work table 7 based on the sensing result from the photosensor 61. When obtaining the position of the medium 2 to be processed, the processing position specifying unit 64 operates the conveyor device 31 (the first motor 37) and the widthwise-direction driving device 54 (the second motor 59) based on a predetermined sensing program. When this sensing program is executed, the photosensor 61 moves in the back-and-forth direction and widthwise direction with respect to the medium 2 to be processed, and senses the reference marks 3 on the medium 2 to be processed.

The embossing control unit 65 has the following two functions. The first function is a function of vertically moving the first pen tool 44 by controlling the operation of the first solenoid 51. The second function is a function of moving the first pen tool 44 in the back-and-forth direction and widthwise direction with respect to the medium 2 to be processed, by controlling the operations of the first motor 37 and second motor 59. When the first pen tool 44 is moved down and the ball 48 is pressed against the medium 2 to be processed, the medium 2 to be processed is recessed while compressing the mat 10, and a recess is formed in the medium 2 to be processed.

When the first pen tool 44 thus pressed against the medium 2 to be processed moves in the back-and-forth direction and widthwise direction with respect to the medium 2 to be processed, an embossed portion as a continuous recess is formed in the medium 2 to be processed. That is, the control device 39 controls the operations of the conveyor device 31, widthwise-direction driving device 54, and first solenoid 51 (the first to third driving devices), and embosses the medium 2 to be processed by the first pen tool 44 (the embossing tool).

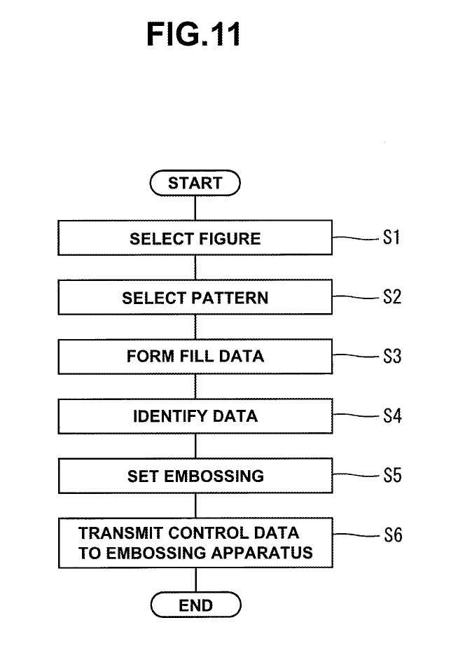

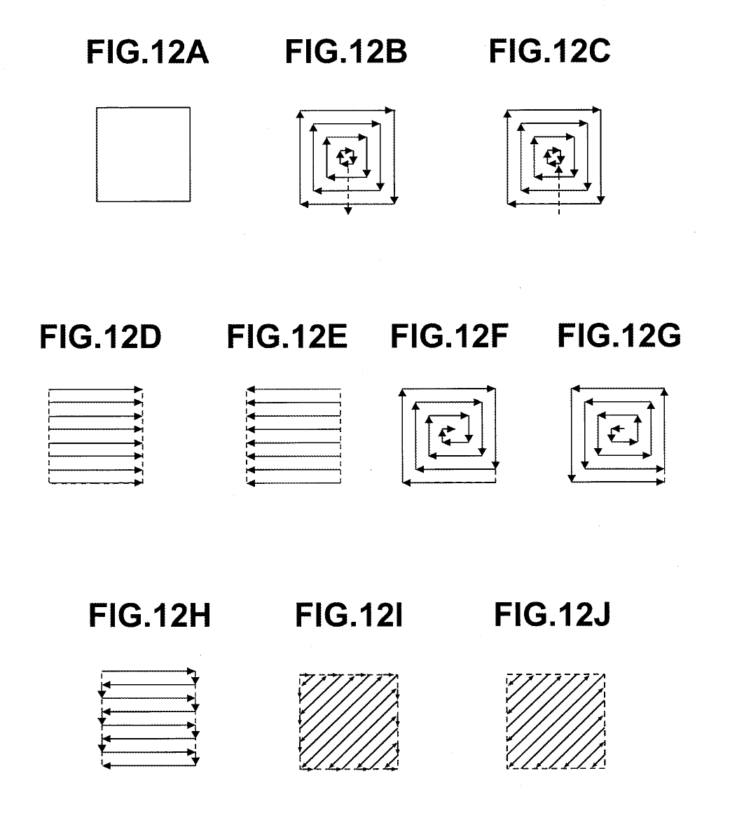

This embossing is performed based on embossing control data transmitted from the personal computer 62. The embossing control data contains detailed contents such as the position of embossing and the shape of an embossing portion. A procedure of forming the embossing control data will be explained with reference to a flowchart shown in FIG. 11 and schematic views shown in FIGS. 12A to 12J.

The embossing control data is formed by a worker by using, e.g., dedicated application software operating on the personal computer 62. The control data contains contour data and fill data (to be described later). The contour data contains data of a line as the contour of an embossing portion. The fill data contains data of a line equivalent to a moving locus when the first pen tool moves in the embossing portion. When setting the contour data in this application software, it is possible to select a method using preregistered figure data and a method of forming new figure data.

To form this control data, figure data as the contour data is selected or new figure data is formed in the above-described application software, in step S1 of the flowchart shown in FIG. 11. In the following description, a case in which a square shown in FIG. 12A is selected as the figure data will be explained.

In step S2, a moving pattern of the first pen tool 44 when embossing the medium 2 to be processed is set. Like an operation of filling a figure with an ink pen, embossing is performed by changing the position of the first pen tool 44 with respect to the medium 2 to be processed based on a predetermined moving pattern. As this moving pattern, nine moving patterns are registered as shown in FIGS. 12B to 12J.

In step S2, one of the nine moving patterns shown in FIGS. 12B to 12J is selected. FIGS. 12B to 12J each illustrate the moving path of a pen when filling a figure with a line drawing. This line drawing shown in each of FIGS. 12B to 12J has a plurality of straight lines arranged in one or both of the back-and-forth direction and widthwise direction. The plurality of straight lines are spaced apart from each other by a predetermined pitch (this pitch will be referred to as a fill pitch hereinafter) in the back-and-forth direction or widthwise direction.

After the moving pattern is selected in step S2, fill data is formed in step S3. This fill data is formed by selecting a fill pitch suitable for the outer diameter of the ball 48, from a plurality of preregistered fill pitches.

After that, the contour data and fill data are made identifiable in step S4. This step is performed by giving different color information to line data contained in the contour data and fill data, or changing layers in which these line data are formed.

Then, setting necessary to perform embossing is performed in step S5. More specifically, the processing speed, pressure, and pen number when embossing the contour and the processing speed, pressure, and pen number when embossing the fill portion are set. The processing speed is a moving velocity when the first or second pen tool 44 or 45 moves relative to the medium 2 to be processed. The pressure is a pressing force when pressing the first or second pen tool 44 or 45 against the medium 2 to be processed. This pressure can be adjusted by changing a voltage to be applied to the solenoid. The pen number is an individual number given to each of the first and second pen tools 44 and 45 in advance.

The control data is formed by performing steps S1 to S5. In step S6, this control data is transmitted to the control device 39 of the embossing apparatus 1 by the worker or application software. The embossing control unit 65 of the control device 39 performs embossing based on this control data.

The cutting control unit 66 of the control device 39 has the following two functions. The first function is a function of vertically moving the second pen tool 45 by controlling the operation of the second solenoid 52. The second function is a function of moving the second pen tool 45 in the back-and-forth direction and widthwise direction with respect to the medium 2 to be processed, by controlling the operations of the first motor 37 and second motor 59. The medium 2 to be processed is cut into a predetermined shape when the second pen tool 45 having the blade moves down and moves in the back-and-forth direction and widthwise direction with respect to the medium 2 to be processed while the blade is piercing the medium 2 to be processed. This cutting is performed based on cutting control data supplied from the personal computer 62. The cutting control data contains data such as the position of cutting and the shape of a cut line. The shape of a cut line can be set into, e.g., a closed shape surrounding an embossing portion. Note that cutting can also be performed by using the embossing control data.

When using an ink pen as the second pen tool 45, the second pen tool 45 moves in the back-and-forth direction and widthwise direction with respect to the medium 2 to be processed based on the above-described embossing control data and cutting control data. A line drawing is drawn on the medium 2 to be processed when the second pen tool 45 thus moves.

To improve the quality of an embossing portion, the control device 39 according to this embodiment can perform embossing by using both of the first and second pen tools 44 and 45. To perform this high-quality embossing, the projection length of the blade of the second pen tool 45 is preset to be smaller than the thickness of the medium 2 to be processed. In this case, the blade edge stops between the upper and lower surfaces of the medium 2 to be processed when the second pen tool 45 moves down, so the medium 2 to be processed is not cut by the blade. When the second pen tool 45 moves in the back-and-forth direction and widthwise direction with respect to the medium 2 to be processed in this state, so-called half-cut is performed on the medium 2 to be processed.

This high-quality embossing using the two types of pen tools as described above is performed based on quality improving control data supplied from the personal computer 62. Like the above-described embossing control data, this quality improving control data is formed by using dedicated application software. The quality improving control data contains data equivalent to the above-described embossing control data, and data equivalent to the above-described cutting control data.

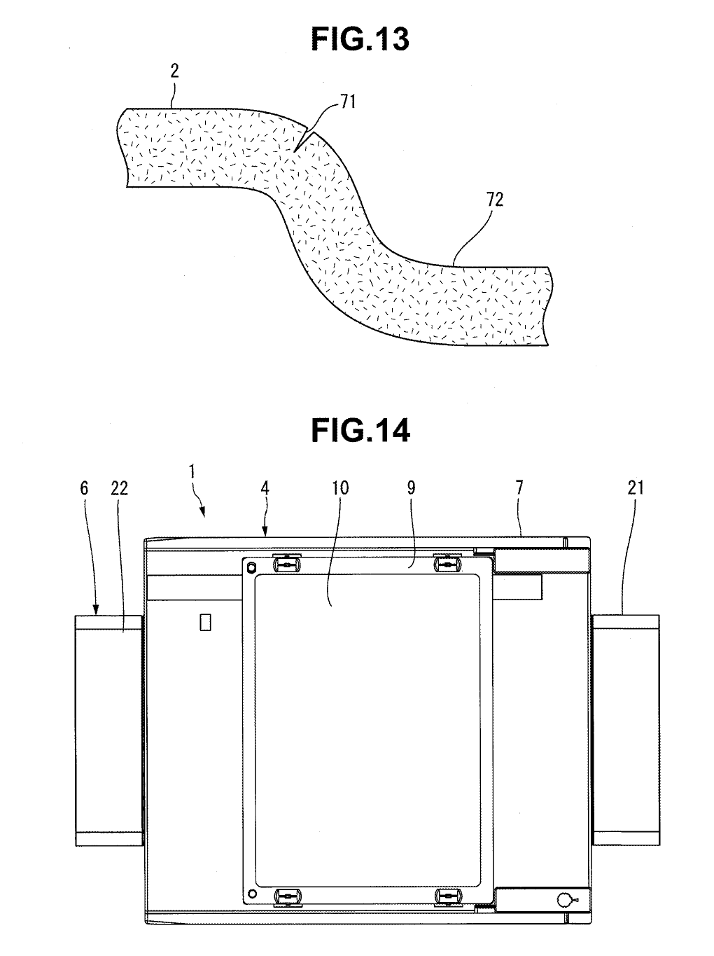

When the quality improving control data is supplied to the control device 39, half-cut is first performed in a predetermined position of the medium 2 to be processed by using the second pen tool 45. When this half-cut is performed, a cut line is formed on the medium 2 to be processed. Then, the first pen tool 44 is pressed against the vicinity (a position determined by a predetermined offset value) of the cut line of the medium 2 to be processed, and embossing is performed along the cut line by the first pen tool 44. By thus using the second pen tool 45 as well, as shown in FIG. 13, a half-cut portion 71 makes the surface of the medium 2 to be processed easily bend, so a three-dimensional embossed portion (recessed portion) 72 having clear edges can be formed in the medium 2 to be processed.

To emboss the medium 2 to be processed by using the embossing apparatus 1 configured as described, the worker first adheres the medium 2 to be processed on the mat 10 of the movable stage 4, and inserts the movable stage 4 into the conveyance path 5. In this state, the plurality of rollers 25 to 28 hold the work table 7, and the pinion 32 meshes with the rack 34. After that, the control device 39 starts control, and first specifies the position of the medium 2 to be processed by using the photosensor 61. In this state, the movable stage 4 moves in the back-and-forth direction by being driven by the conveyor device 31, and the pen carriage 43 moves in the widthwise direction by being driven by the widthwise-direction driving device 54. After that, one of the first and second pen tools 44 and 45, which is necessary for processing, moves to a predetermined processing start position.

Embossing is performed by using the first pen tool 44. Cutting or half-cut of the medium 2 to be processed or drawing of a line drawing is performed by using the second pen tool 45. After these processes are complete, a product having undergone embossing or drawing is obtained by separating the medium 2 to be processed from the mat 10. The mat 10 is depressed as it is partially compressed by embossing, but returns to the initial shape by its own elasticity after the medium 2 to be processed is separated.

In the embossing apparatus 1 of this embodiment, the medium 2 to be processed is fed when the work table 7 on which the medium 2 to be processed is placed is translated. When compared to the embossing apparatus disclosed in literature 2, therefore, embossing can be performed in a low position. Also, the media 2 to be processed are sheets and hence can be fed one by one. When compared to the embossing apparatus disclosed in literature 2, therefore, the supply reel is unnecessary, so the occupation area for installation can be small. Accordingly, this embodiment can provide a an embossing apparatus which is downsized although it has the function of feeding the medium 2 to be processed, and the function of moving the first and second pen tools 44 and 45 in the widthwise direction perpendicular to the feeding direction of the medium 2 to be processed, and can perform embossing in an arbitrary position without using any die.

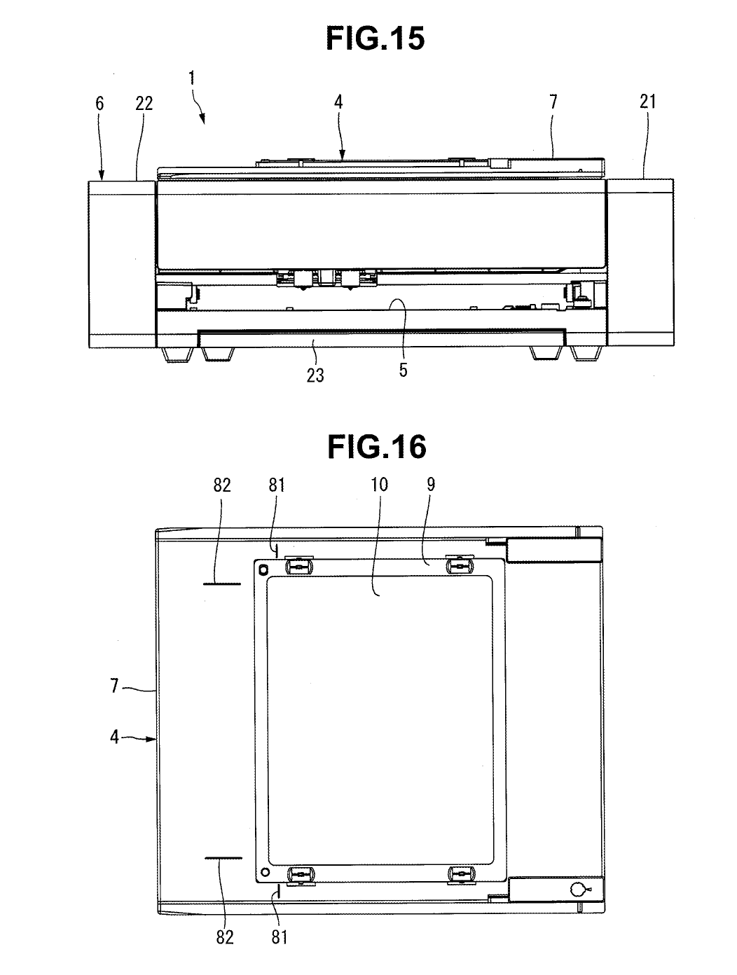

The movable stage 4 of the embossing apparatus 1 is detachable from the embossing apparatus main body 6. As shown in FIGS. 14 and 15, therefore, the movable stage 4 can be kept on the embossing apparatus main body 6 when not in use. In this state, the occupation space for keeping is narrowed by overlaying the embossing apparatus main body 6 and movable stage 4 such that their longitudinal directions are parallel.

The mat 10 according to this embodiment is formed by a soft foam, and the medium 2 to be processed can be adhered on and separated from the mat 10. Accordingly, the medium 2 to be processed can be adhered on the mat 10 without using any sticker or adhesive, and can easily be separated from the mat 10 after being processed. Therefore, this embodiment can provide an embossing apparatus having high workability because the sheet-like medium 2 to be processed can easily be handled.

The conveyor device 31 (the first driving device) according to this embodiment includes the rack 34 formed on the work table 7 in parallel to the direction in which the conveyance path 5 extends, and the first motor 37 for rotating the pinion 32 which meshes with the rack 34. The work table 7 moves along the conveyance path 5 when the pinion 32 rotates by being driven by the first motor 37. The rack 34 can be formed along the work table 7. Therefore, this embodiment can provide a further downsized embossing apparatus because the conveyor device 31 can be made compact.

The pen carriage 43 according to this embodiment includes the second pen tool 45 different from the first pen tool 44 for embossing, and the second solenoid 52 (the fourth driving device) for selectively pressing the second pen tool 45 against the medium 2 to be processed adhered on the mat 10. The embossing apparatus 1 according to this embodiment can cut and decorate an embossing portion by using the second pen tool 45. That is, when using a cutting pen having a blade as the second pen tool 45, an embossed product can be cut out from the medium 2 to be processed and hence can rapidly be obtained. When using a pen tool having an ink pen as the second pen tool 45, the interior or vicinity of an embossed portion can be decorated by a line drawing. Also, when using embossing tools different in size of a pressing portion as the second pen tool 45, it is possible to perform embossing processes different in depth or area of a recess.

Furthermore, when using a cutting pen capable of half-cut as the second pen tool 45, the quality of an embossed portion can be improved.

The reference marks 3 (marks) for position specification are formed in predetermined positions of the medium 2 to be processed according to this embodiment. The pen carriage 43 includes the photosensor 61 for sensing the reference marks 3. The control device 39 has a function of obtaining the position of the medium 2 to be processed with respect to the work table 7 based on the sensing result from the photosensor 61. In the embossing apparatus 1 configured as described above, the position of the medium 2 to be processed is automatically sensed, so it is unnecessary to perform any aligning work when adhering the medium 2 to be processed on the mat 10. In this embodiment, therefore, it is possible to further easily perform the work of adhering the medium 2 to be processed on the mat 10.

### Another Embodiment of Movable Stage

The adhesion positions of the medium 2 to be processed can be specified without using the photosensor 61, by adhering the medium 2 to be processed on predetermined adhesion positions. To adopt this configuration, as shown in FIG. 16, first marks 81 and second marks 82 for positioning are formed on the work table 7. The first and second marks 81 and 82 are formed in predetermined adhesion positions.

The first marks 81 are used to determine a position in the back-and-forth direction, and formed into straight lines extending in the widthwise direction. The medium 2 to be processed is positioned in the back-and-forth direction by matching the edge of the medium 2 to be processed in the back-and-forth direction with the first marks 81 in the back-and-forth direction. The second marks 82 are used to determine a position in the widthwise direction, and formed into straight lines extending in the back-and-forth direction. The medium 2 to be processed is positioned in the widthwise direction by matching the edge of the medium 2 to be processed in the widthwise direction with the second marks 82 in the widthwise direction.

The first and second marks 81 and 82 can also be formed on another member of the movable stage 4. That is, the first and second marks 81 and 82 can be formed on at least one of the work table 7, plate-like spacer 8, base plate 9, and mat 10. When using the first and second marks 81 and 82 as described above, the adhesion positions of the medium 2 to be processed can be specified without using the photosensor 61. Since the photosensor 61 is unnecessary, therefore, an embossing apparatus which can be manufactured at low cost can be provided.

What is claimed is:

1. An embossing apparatus comprising:
a base including a conveyance path extending in a first direction;
a work table formed into a plate shape, and detachably attached to the conveyance path such that the work table is movable in the first direction with a major surface of the work table being parallel to the conveyance path;
a mat which is arranged on the work table, and formed into a plate shape by a material having flexibility and elasticity, and on which a medium to be processed is adhered;
a first driving device configured to move the work table in the first direction;
a pen carriage spaced apart from the base, and supported to be movable in a second direction parallel to the major surface of the work table attached to the conveyance path and different from the first direction;
a second driving device configured to move the pen carriage in the second direction;
a first tool arranged on the pen carriage such that the first tool is movable in a third direction perpendicular to the major surface of the work table, and configured to form a recess in the medium to be processed when pressed against the medium to be processed adhered on the mat;
a third driving device arranged on the pen carriage, and configured to move the first tool in the third direction, and selectively press the first tool against the medium to be processed adhered on the mat; and
a control device configured to control operations of the first driving device, the second driving device, and the third driving device, and perform embossing on the medium to be processed by the first tool.

2. The apparatus according to claim 1, wherein the mat is formed by a soft foam, and the medium to be processed can be adhered on and separated from the mat.

3. The apparatus according to claim 1, wherein the first driving device comprises:
a rack formed parallel to the first direction on a surface opposite to the major surface of the work table;
a pinion arranged on the base and configured to mesh with the rack; and
a motor configured to rotate the pinion.

4. The apparatus according to claim 1, wherein the pen carriage further comprises:
a second tool different from the first tool; and
a fourth driving device configured to move the second tool in the third direction, and selectively press the second tool against the medium to be processed adhered on the mat.

5. The apparatus according to claim 1, further comprising a mark formed on at least one of the mat and the work table, and configured to position the medium to be processed in a predetermined adhesion position.

6. The apparatus according to claim 1, wherein
the medium to be processed includes a mark as a reference position in a predetermined position,
the pen carriage comprises a sensor configured to sense the mark, and
the control device comprises a specifying unit configured to specify a position of the medium to be processed with respect to the work table based on a sensing result from the sensor.
